(19) United States
(12) Patent Application Publication
(10) Pub. No.: US 2018/0053580 A1
(43) Pub. Date: Feb. 22, 2018

(54) LOW-DIELECTRIC CONSTANT POLYIMIDE INSULATION COATING AND ENAMELED WIRE

(71) Applicant: TA YA ELECTRIC WIRE & CABLE CO., LTD., Tainan City (TW)

(72) Inventors: WEI-FANG SU, NEW TAIPEI CITY (TW); MING-HAN CHIANG, TAINAN CITY (TW); CHI-FENG HUNG, TAINAN CITY (TW); HUI-JU TSAI, TAINAN CITY (TW); YA-TING CHANG, TAINAN CITY (TW); YING-JU LIN, TAINAN CITY (TW); TING-I LU, TAINAN CITY (TW)

(21) Appl. No.: 15/238,072

(22) Filed: Aug. 16, 2016

(51) Int. Cl. H01B 3/30; C09D 179/08

(52) U.S. Cl. CPC H01B 3/306; C09D 179/08

(57) ABSTRACT

Provided is a polyimide insulation coating, which is prepared by reacting a diacid anhydride compound represented by Formula (I) with a diamine compound represented by Formula (II).

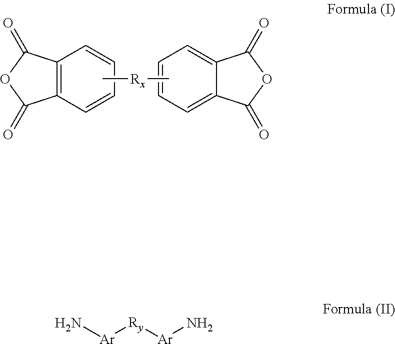

By adopting the specific diacid anhydride compound and the specific diamine compound, the synthesized polyimide insulation coating can have a dielectric constant less than 3. Accordingly, the enameled wire having an insulation layer formed from the polyimide insulation coating would not readily produce partial discharge, thereby avoiding the penetrating short-circuit and the damage to the motor.

### BACKGROUND OF THE INVENTION

### 1. Field of the Invention

The present invention relates to an insulation material for coating, more particularly to a polyimide insulation coating and an enameled wire with an insulation layer formed by curing the polyimide insulation coating.

### 2. Description of the Prior Arts

With the growing problems of global warming and air pollution, the awareness on environmental protection has been raised and received more attention from the public. Energy conservation and high efficiency become important issues for developing new electronic machinery products. To achieve energy conservation, design of variable-frequency operation of the motor, such as the motor driven by the inverter, has been considered as the technical breakthrough in the related field.

However, the motor driven by the inverter typically generates high-voltage surge during the operation. When the surge voltage is higher than the partial discharge inception voltage (PDIV) of the enameled wires of the motor windings, the enameled wire with overly high dielectric constant is apt to produce partial discharge during the operation, thereby eroding the insulation film of the enameled wire and eventually causing the penetrating short-circuit and the damage of the motor system.

To suppress the partial discharge occurring at the high voltage rotary motor or transformer, one of the conventional methods increases the thickness of the insulation film of the enameled wire to resist the partial discharge and allow the enameled wire to sustain the erosion by partial discharge. Another conventional method uses ceramic powders in the preparation of the insulation film to enhance the structural strength of the insulation film, aiming to extend the life of the insulation film of the enameled wire and prevent the insulation film and the motor from being damaged.

However, the thick insulation film of the enameled wire increases the overall volume of the rotary motor or transformer and thus impedes the achievement of miniaturization. The use of ceramic powders reduces the flexibility of the enameled wire and roughens the surface of the insulation film. Such a modified enameled wire is easily worn and damaged by the roughened insulation film during winding, thereby reducing the production yield and bringing the difficulty in fabrication.

### SUMMARY OF THE INVENTION

In view of the drawbacks in the prior art, one of the objectives of the present invention is to modify the coating composition for the insulation film of the enameled wire, so as to increase the partial discharge inception voltage, PDIV, of the enameled wire without increasing the thickness of the insulation film and using ceramic powders in the preparation of the insulation film. Accordingly, the flexibility of the enameled wire and the flatness of the insulation film would be maintained, such that deterioration of the enameled wire can be effectively avoided.

Another objective of the present invention is to increase the PDIV to be higher than the surge voltage, enabling the enameled wire to sustain a higher surge voltage and suppressing the occurrence of the partial discharge. Therefore, the problems of erosion of the insulation film and the damage of the motor caused by partial discharge can be overcome.

To achieve the foresaid objectives, the present invention provides a low-dielectric constant polyimide insulation coating, which is prepared by the reaction between a diacid anhydride compound and a diamine compound.

The diacid anhydride compound is represented by the following Formula (I):

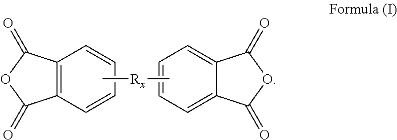

In Formula (I), “Rₓ” is selected from the group consisting of: —O—, —CO—, and —O—Ar—R₁—Ar—O—, and “Ar” is an aromatic hydrocarbon compound. “R₁” is selected from the group consisting of: —C(CH₃)₂—, —C(CH₃)(C₂H₅)—, —C(C₂H₅)₂—, —C(CF₃)₂—, —C(CF₃)(CH₃)—, and —C(CF₃)(C₂H₅)—.

The diamine compound is represented by the following Formula (II):

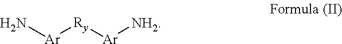

In Formula (II), “R_{y}” is selected from the group consisting of: —C(CF₃)₂—, —CO—, —SO₂—, —O—Ar—R₂—Ar—O—, and —O—(Ar)ₙ—O—, “n” is a positive integral from 1 to 5, and “Ar” is an aromatic hydrocarbon compound. “R₂” is selected from the group consisting of: —C(CH₃)₂—, —C(CH₃)(C₂H₅)—, —C(C₂H₅)₂—, —C(CF₃)₂—, —C(CF₃)(CH₃)—, —C(CF₃)(C₂H₅)—, and —CO—.

In accordance with the present invention, the polyimide insulation coating prepared by reacting a specific diacid anhydride compound and a specific diamine compound as described above can have the property of low dielectric constant, and thus is particularly suitable to form a low-dielectric constant insulation layer.

Preferably, the molar ratio of the diacid anhydride compound to the diamine compound is equal to or more than 0.9:1 and equal to or less than 1:1.

Preferably, the dielectric constant of the polyimide insulation coating of the present invention is less than 3. By reducing the dielectric constant of the polyimide insulation coating, the polyimide insulation layer formed by the polyimide insulation coating has an improved PDIV, such that the polyimide insulation layer coated on a conductive core wire allows the enameled wire to sustain higher surge voltage, suppresses the generation of the partial discharge, and prevents the insulation layer of the enameled wire from being eroded by the partial discharge. Accordingly, the low-dielectric constant polyimide insulation coating is useful to prevent the penetrating short-circuit and the damage of the motor system or the electronic components.

More preferably, “Rₓ” in Formula (I) may be —CO—, —O—Ar—C(CH₃)₂—Ar—O—, or their combination. Said “Ar” is an aromatic hydrocarbon compound. When “Rₓ” is —CO—, the diacid anhydride compound is 4,4′-carbonyldiphthalic anhydride, BTDA. When “Rₓ” is —O—Ar—C(CH₃)₂—Ar—O—, the diacid anhydride compound is 4,4′-(4,4′-isopropylidenediphenoxy)bis(phthalic anhydride), BPADA.

Preferably, the diacid anhydride compound includes a first diacid anhydride and a second diacid anhydride, both represented by the above Formula (I). For the first diacid anhydride, “Rₓ” in Formula (I) is —CO—. For the second diacid anhydride, “Rₓ” in Formula (I) is —O—Ar—C(CH₃)₂—Ar—O—. That is, in one embodiment of the present invention, the low-dielectric constant polyimide insulation coating is prepared by reacting a diamine compound with the first diacid anhydride, e.g., BTDA, and the second diacid anhydride, e.g., BPADA.

Preferably, “R_{y}” in Formula (II) may be —O—Ar—O—, —O—(Ar)₂—O—, —O—Ar—C(CH₃)₂—Ar—O—, or —O—Ar—C(CF₃)₂—Ar—O—, and the “Ar” is an aromatic hydrocarbon compound. When “R_{y}” is —O—Ar—O—, the diamine compound is 1,4-bis(4-aminophenoxy)benzene, p-BAB. When “R_{y}” is —O—(Ar)₂—O—, the diamine compound is 4,4′-bis(4-aminophenoxy)biphenyl, BAPB. When “R_{y}” is —O—Ar—C(CH₃)₂—Ar—O—, the diamine compound is 2,2-bis[4-(4-aminophenoxy)phenyl]propane, BAPP. When “R_{y}” is —O—Ar—C(CF₃)₂—Ar—O—, the diamine compound is 2,2-bis[4-(4-aminophenoxy)phenyl]hexafluoropropane, HFBAPP.

Preferably, the reaction between the diacid anhydride compound and the diamine compound is conducted under a nitrogen atmosphere and at room temperature. Under the chemically inert nitrogen atmosphere, there is no need to worry that the nitrogen gas will participate in the reaction and modification of the products.

To achieve the foresaid objectives, the present invention also provides an enameled wire. The enameled wire has a conductive core wire and a first low-dielectric constant insulation layer capped around the conductive core wire. The first low-dielectric constant insulation layer is formed by curing the low-dielectric constant polyimide insulation coating as mentioned above.

By curing the low-dielectric constant polyimide insulation coating to form a low-dielectric constant insulation layer, the enameled wire having the insulation layer would not readily produce partial discharge during operation, and the erosion to the first low-dielectric constant insulation layer can be avoided. Accordingly, the present invention is effective to prevent penetrating short-circuit so as to suppress the damage of the motor system caused by partial discharge.

Preferably, the enameled wire of the present invention further has a second low-dielectric constant insulation layer formed between the conductive core wire and the second low-dielectric constant insulation layer, and the second low-dielectric constant insulation layer is capped around an exterior of the first low-dielectric constant insulation layer. Like the first low-dielectric constant insulation layer, the second low-dielectric constant insulation layer is also formed by curing the low-dielectric constant polyimide insulation coating as mentioned above. With the multilayered insulation structure formed around the conductive core wire, the enameled wire can have a low dielectric constant, and thus is not readily eroded by the partial discharge.

In conclusion, by reacting a specific diacid anhydride compound with a specific diamine compound, the prepared polyimide insulation coating can have a dielectric constant less than 3. In comparison with the conventional polyimide insulation coating, an enameled wire having a polyimide insulation layer formed by the polyimide insulation coating can have a higher PDIV, such that the enameled wire of the present invention would not produce partial discharge at a voltage less than the PDIV and be eroded and damaged by the partial discharge. Accordingly, the life of the enameled wire and the related products can be effectively extended by using the polyimide insulation coating.

Further, the technical means of thickening the insulation layer of the enameled wire and adding ceramic powders are no more required to extend the life of the enameled wire. Accordingly, the original volume, flexibility, and flatness of the enameled wire can be maintained without deteriorating the winding process.

Other objectives, advantages and novel features of the invention will become more apparent from the following detailed description when taken in conjunction with the accompanying drawings.

### DETAILED DESCRIPTION OF THE PREFERRED EMBODIMENTS

To verify the effects of the low-dielectric constant polyimide insulation coating, multiple examples of the low-dielectric constant polyimide insulation coatings for preparing the insulation layers of the enameled wire are provided. The descriptions proposed herein are just preferable embodiments for the purpose of illustrations only, not intended to limit the scope of the invention. One person skilled in the art can easily realize the advantages and effects of the low-dielectric constant polyimide insulation coating and the enameled wire in accordance with the present invention from the following examples. Various modifications and variations could be made in order to practice or apply the present invention without departing from the spirit and scope of the invention.

### Example 1-1: Low-Dielectric Constant Polyimide Insulation Coating

A glass reaction flask equipped with a nitrogen inlet and a feeder was charged with N-methyl-2-pyrrolidone (NMP) and 1 mole of 4,4′-bis(4-aminophenoxy)biphenyl (BAPB, molecular weight: 368.43), under a nitrogen atmosphere and at room temperature, and then stirred to allow the BAPB to fully dissolve in NMP. Then 0.8 moles of 4,4′-(4,4′-isopropylidenediphenoxy)bis(phthalic anhydride) (BPADA, molecular weight: 520.49) and 0.2 moles of 4,4′-carbonyldiphthalic anhydride (BTDA, molecular weight: 322.2) were added from the feeder and then reacted with BAPB in NMP at room temperature for 24 hours, so as to prepare the polyimide insulation coating of Example 1-1.

### Example 1-2: Enameled Wire with a Single Insulation Layer A

In the instant example, the low-dielectric constant polyimide insulation coating prepared by Example 1-1 was coated onto the outer surface of conductive core wire (diameter: 0.5 mm) and then baked and cured to form a single insulation layer A on the outer surface of conductive core wire. The enameled wire with a 0.034 mm-thick single insulation layer A was obtained.

### Example 2-1: Low-Dielectric Constant Polyimide Insulation Coating

A glass reaction flask equipped with a nitrogen inlet and a feeder was charged with NMP and 1 mole of 1,4-bis(4-aminophenoxy)benzene (p-BAB, molecular weight: 292.33), under a nitrogen atmosphere and at room temperature, and then stirred to allow the p-BAB to fully dissolve in NMP. After that, 1 mole of BTDA was added from the feeder and then reacted with p-BAB in NMP at room temperature for 24 hours, so as to prepare the polyimide insulation coating of Example 2-1.

### Example 2-2: Enameled Wire with a Single Insulation Layer B

In the instant example, the low-dielectric constant polyimide insulation coating prepared by Example 2-1 was coated onto the outer surface of conductive core wire (diameter: 0.5 mm) and then baked and cured to form a single insulation layer B on the outer surface of conductive core wire. The enameled wire with a 0.034 mm-thick single insulation layer B was obtained.

### Example 3-1: Low-Dielectric Constant Polyimide Insulation Coating

A glass reaction flask equipped with a nitrogen inlet and a feeder was charged with NMP and 1 mole of 2,2-bis[4-(4-aminophenoxy)phenyl]propane (BAPP, molecular weight: 410.5), under a nitrogen atmosphere and at room temperature, and then stirred to allow the BAPP to fully dissolve in NMP. After that, 1 mole of BTDA was added from the feeder and then reacted with BAPP in NMP at room temperature for 24 hours, so as to prepare the polyimide insulation coating of Example 3-1.

### Example 3-2: Enameled Wire with a Single Insulation Layer C

The aforementioned low-dielectric constant polyimide insulation coating prepared by Example 3-1 was coated onto the outer surface of conductive core wire (diameter: 0.5 mm) and then baked and cured to form a single insulation layer C on the outer surface of conductive core wire. The enameled wire with a 0.034 mm-thick single insulation layer C was obtained.

### Example 4-1: Low-Dielectric Constant Polyimide Insulation Coating

A glass reaction flask equipped with a nitrogen inlet and a feeder was charged with NMP and 1 mole of 2,2-bis[4-(4-aminophenoxy)phenyl]hexafluoropropane (HFBAPP, molecular weight: 518.5), under a nitrogen atmosphere and at room temperature, and then stirred to allow the HFBAPP to fully dissolve in NMP. After that, 1 mole of BPADA was added from the feeder and then reacted with HFBAPP in NMP at room temperature for 24 hours, so as to prepare the polyimide insulation coating of Example 4-1.

### Example 4-2: Enameled Wire with a First Insulation Layer C′ and a Second Insulation Layer D

The aforementioned low-dielectric constant polyimide insulation coating prepared by Example 3-1 was coated onto the outer surface of conductive core wire (diameter: 0.5 mm) and then baked and cured to form a first insulation layer C′ on the outer surface of conductive core wire. Then the low-dielectric constant polyimide insulation coating prepared by Example 4-1 was further coated onto the outer surface of the first insulation layer C′, and baked and cured to form a second insulation layer D on the outer surface of the first insulation layer C′. Finally, the enameled wire with double insulation layers was obtained. Herein, the thickness of the first insulation layer C′ was 0.004 mm, and the thickness of the second insulation layer D was 0.03 mm. That is, the total thickness of the first insulation layer C′ and the second insulation layer D was also 0.034 mm, identical to the thickness of each of the single insulation layers as prepared in Examples 1-2, 2-2, and 3-2.

### Comparative Example 1-1: Conventional Polyimide Insulation Coating

A glass reaction flask equipped with a nitrogen inlet and a feeder was charged with NMP and 1 mole of 4,4′-diaminodiphenyl ether (ODA, molecular weight: 200.24), under a nitrogen atmosphere and at room temperature, and then stirred to allow the ODA to fully dissolve in NMP. After that, 1 mole of 3,3′,4,4′-biphenyltetracarboxylic dianhydride (BPDA, molecular weight: 322.2) was added from the feeder and then reacted with ODA in NMP at room temperature for 24 hours, so as to prepare the polyimide insulation coating of Comparative Example 1-1.

### Comparative Example 1-2: Enameled Wire with a Single Insulation Layer E

The polyimide insulation coating prepared by Comparative Example 1-1 was coated onto the outer surface of conductive core wire (diameter: 0.5 mm) and then baked and cured to form a single insulation layer E on the outer surface of conductive core wire. The enameled wire with a 0.034 mm-thick single insulation layer E was obtained.

### Test Example

To assess the properties of the polyimide insulation coatings of Examples 1-1, 2-1, 3-1, 4-1 and Comparative Example 1-1, each of the enameled wires of Examples 1-2, 2-2, 3-2, 4-2 and Comparative Example 1-2, which comprised coating layer(s) formed from the foresaid polyimide insulation coating(s), was analyzed by the following methods.

The dielectric breakdown voltage, thermoplastic flow temperature, pinhole, adherence, heat shock resistance, and flexibility of the enameled wire were determined according to the methods and standards of ANSI/NEMA MW MW 16-C. Results were listed in Table 1.

Regarding the dielectric constant of the enameled wire, each of the enameled wires in a length over 110 cm was coated with graphite in a length over 100 cm to form the electrode. The capacitance of the electrode and conductor was measured by a LCR meter at 50 Hz, and the dielectric constant was calculated by the relation of the length of electrode and the insulation thickness. Results were also listed in Table 1.

Regarding the PDIV of the enameled wire, 50 cm of enameled wire was folded. An end of the folded enameled wire was twisted according to the method of ANSI/NEMA MW 1000, and another end of the folded enameled wire was scraped to remove the insulation layer and expose the conductive core wire in a length about 1 cm. After that, the twisted wire specimen was measured using a partial discharge automatic system (DAC-6031, manufactured by Soken Electric Co., Ltd.), applied with 50 Hz voltage in an atmosphere at 25° C. and relative humidity of 60% while increasing the voltage at a rate of 25 V/sec.

The voltage at which partial discharge of 50 Pc occurs 50 times of the twisted wire specimen was measured as the PDIV. Results were also listed in Table 1.

TABLE 1
the results of total thickness of the insulation layer(s), the dielectric
constant, PDIV, dielectric breakdown voltage, thermoplastic flow
temperature, pinhole test, adherence test, heat shock resistance test,
and flexibility test of the enameled wires of Examples 1-2, 2-2, 3-2,
4-2, and Comparative Example 1-2

| | Example No. | | | | |
|---|---|---|---|---|---|
| | Example | Example | Example | Example | Comparative |
| | 1-2 | 2-2 | 3-2 | 4-2 | Example 1-2 |
| Total | 0.034 | 0.034 | 0.034 | 0.034 | 0.034 |
| thickness of | | | | | |
| insulation | | | | | |
| layer (mm) | | | | | |
| Dielectric | 2.95 | 2.83 | 2.91 | 2.86 | 3.83 |
| constant | | | | | |
| PDIV (Vp) | 766 | 740 | 705 | 716 | 540 |
| Dielectric | 8460 | 13290 | 13660 | 13090 | 3810 |
| Breakdown | | | | | |
| voltage (V) | | | | | |
| Thermoplastic | 468 | >480 | 473 | 476 | 456 |
| flow temp. (° C.) | | | | | |
| Pinhole | No | No | No | No | Lots of |
| | pinhole | pinhole | pinhole | pinhole | pinholes |
| Adherence | No crack | No crack | No crack | No crack | Cracked |
| Heat shock | Passed | Passed | Passed | Passed | Failed |
| resistance | | | | | |
| Flexibility | Passed | Passed | Passed | Passed | Failed |

According to the results of Examples 1-2, 2-2, and 3-2, each of the enameled wires with a 0.034 mm-thick single insulation layer had a dielectric constant less than 3 and a PDIV higher than 700 Vp when the insulation layer of the enameled wire was formed by curing the low-dielectric constant polyimide insulation coating of each of Examples 1-1, 2-1, and 3-1. For the enameled wire with double insulation layers, whose total thickness of the insulation layers was also 0.034 mm, the enameled wire of Example 4-2 also had a dielectric constant less than 3 and a PDIV higher than 700 Vp when the double insulation layers were respectively formed by curing two different low-dielectric constant polyimide insulation coatings.

Furthermore, the dielectric breakdown voltage, thermoplastic flow temperature under thermal treatment, pinhole distribution, adherence, heat shock resistance, and flexibility of the enameled wires of Examples 1-2, 2-2, 3-2, and 4-2 met the standards of ANSI/NEMA MW 1000 MW 16-C.

In contrast, the enameled wire of Comparative Example 1-2 had a dielectric constant much more than 3 and a PDIV merely 540 Vp when the single insulation layer was formed by curing the conventional polyimide insulation coating. If the surge voltage was higher than 540 Vp, the partial discharge occurred, thereby eroding the single insulation layer E of the enameled wire of Comparative Example 1-2, causing the penetrating short-circuit and damaging the motor system.

According to the results of ANSI/NEMA MW 1000 MW 16-C, the dielectric breakdown voltage, the thermoplastic flow temperature, the pinhole, the adherence, the heat shock resistance, and the flexibility of the enameled wire of Comparative Example 1-2 were not comparable to those of Examples 1-2, 2-2, 3-2, and 4-2. More particularly, the enameled wire of Comparative Example 1-1 failed to pass the heat shock resistance and the flexibility tests according to the standards set by American National Standards Institute.

Based on the foregoing results, the polyimide insulation materials prepared by reacting a specific diacid anhydride compound with a specific diamine compound can have a dielectric constant less than 3, and thus the polyimide insulation coating formed by curing thereof also exhibits a dielectric constant less than 3. Thus, curing the polyimide insulation coating to form a 0.034 mm-thick of low-dielectric constant insulation layer onto the conductive core wire can prepare an enameled wire capable of sustaining a PDIV more than 700 Vp. The enameled wire in accordance with the present invention would not be readily eroded by the partial discharge compared to the conventional enameled wire. Accordingly, the technical means of the present invention is effective to avoid the penetrating short-circuit, enabling to largely reduce the possibility of damage to the motor system and to extend the product life.

In comparison with the technical means in the prior art, the present invention can successfully extend the life of the enameled wire with the polyimide insulation layer without adding ceramic powders and without increasing the thickness of the insulation film. Thus, the present invention can ensure the overall volume of the enameled wire without expansion, maintain the flexibility of the enameled wire, and prevent the enameled wire being damaged by the roughened insulation film during winding simultaneously, and thus does overcome many drawbacks in the prior art.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A low-dielectric constant polyimide insulation coating, which is prepared by reacting a diacid anhydride compound with a diamine compound, wherein the diacid anhydride compound is represented by Formula (I): 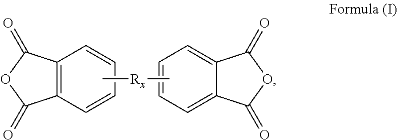
wherein Rₓ is selected from the group consisting of: —O—, —CO—, and —O—Ar—R₁—Ar—O—, Ar is an aromatic hydrocarbon compound, and R₁ is selected from the group consisting of: —C(CH₃)₂—, —C(CH₃)(C₂H₅)—, —C(C₂H₅)₂—, —C(CF₃)₂—, —C(CF₃)(CH₃)—, and —C(CF₃)(C₂H₅)—;
wherein the diamine compound is represented by Formula (II): 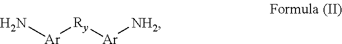
wherein R_{y} is selected from the group consisting of: —C(CF₃)₂—, —CO—, —SO₂—, —O—Ar—R₂—Ar—O—, and —O—(Ar)ₙ—O—, n is from 1 to 5, Ar is an aromatic hydrocarbon compound, and R₂ is selected from the group consisting of: —C(CH₃)₂—, —C(CH₃)(C₂H₅)—, —C(C₂H₅)₂—, —C(CF₃)₂—, —C(CF₃)(CH₃)—, —C(CF₃)(C₂H₅)—, and —CO—.

2. The low-dielectric constant polyimide insulation coating as claimed in claim 1, wherein the molar ratio of the diacid anhydride compound to the diamine compound is equal to or more than 0.9:1 and equal to or less than 1:1.

3. The low-dielectric constant polyimide insulation coating as claimed in claim 1, wherein the low-dielectric constant polyimide insulation coating has a dielectric constant less than 3.

4. The low-dielectric constant polyimide insulation coating as claimed in claim 2, wherein the low-dielectric constant polyimide insulation coating has a dielectric constant less than 3.

5. The low-dielectric constant polyimide insulation coating as claimed in claim 1, wherein Rₓ in Formula (I) is —CO— or —O—Ar—C(CH₃)₂—Ar—O—.

6. The low-dielectric constant polyimide insulation coating as claimed in claim 2, wherein Rₓ in Formula (I) is —CO— or —O—Ar—C(CH₃)₂—Ar—O—.

7. The low-dielectric constant polyimide insulation coating as claimed in claim 1, wherein the diacid anhydride compound includes a first diacid anhydride and a second diacid anhydride, the first diacid anhydride and the second diacid anhydride are represented by Formula (I), Rₓ of the first diacid anhydride is —CO—, and Rₓ of the second diacid anhydride is —O—Ar—C(CH₃)₂—Ar—O—.

8. The low-dielectric constant polyimide insulation coating as claimed in claim 2, wherein the diacid anhydride compound includes a first diacid anhydride and a second diacid anhydride, the first diacid anhydride and the second diacid anhydride are represented by Formula (I), Rₓ of the first diacid anhydride is —CO—, and Rₓ of the second diacid anhydride is —O—Ar—C(CH₃)₂—Ar—O—.

9. The low-dielectric constant polyimide insulation coating as claimed in claim 1, wherein R_{y} in Formula (II) is —O—Ar—O— or —O—(Ar)₂—O—.

10. The low-dielectric constant polyimide insulation coating as claimed in claim 2, wherein R_{y} in Formula (II) is —O—Ar—O— or —O—(Ar)₂—O—.

11. The low-dielectric constant polyimide insulation coating as claimed in claim 5, wherein R_{y} in Formula (II) is —O—Ar—O— or —O—(Ar)₂—O—.

12. The low-dielectric constant polyimide insulation coating as claimed in claim 7, wherein R_{y} in Formula (II) is —O—Ar—O— or —O—(Ar)₂—O—.

13. The low-dielectric constant polyimide insulation coating as claimed in claim 1, wherein R_{y} in Formula (II) is —O—Ar—C(CH₃)₂—Ar—O— or —O—Ar—C(CF₃)₂—Ar—O—.

14. The low-dielectric constant polyimide insulation coating as claimed in claim 2, wherein R_{y} in Formula (II) is —O—Ar—C(CH₃)₂—Ar—O— or —O—Ar—C(CF₃)₂—Ar—O—.

15. The low-dielectric constant polyimide insulation coating as claimed in claim 5, wherein R_{y} in Formula (II) is —O—Ar—C(CH₃)₂—Ar—O— or —O—Ar—C(CF₃)₂—Ar—O—.

16. The low-dielectric constant polyimide insulation coating as claimed in claim 7, wherein R_{y} in Formula (II) is —O—Ar—C(CH₃)₂—Ar—O— or —O—Ar—C(CF₃)₂—Ar—O—.

17. An enameled wire, having a conductive core wire and a first low-dielectric constant coating layer capped around the conductive core wire, wherein the first low-dielectric constant coating layer is formed by curing the low-dielectric constant polyimide insulation coating as claimed in claim 1.

18. The enameled wire as claimed in claim 17, wherein the enameled wire has a second low-dielectric constant insulation layer capped around an exterior of the first low-dielectric constant insulation layer, the first low-dielectric constant insulation layer is formed between the conductive core wire and the second low-dielectric constant insulation layer, and the second low-dielectric constant insulation layer is formed by curing the low-dielectric constant polyimide insulation coating as claimed in claim 1.

19. The enameled wire as claimed in claim 17, wherein the enameled wire has a dielectric constant less than 3.
